(19) United States
(12) Patent Application Publication
(10) Pub. No.: US 2014/0334833 A1
(43) Pub. Date: Nov. 13, 2014

(54) SHEET CONVEYING APPARATUS, METHOD FOR CONTROLLING THE SAME AND PROGRAM

(71) Applicant: CANON KABUSHIKI KAISHA, Tokyo (JP)

(72) Inventor: Takuto Harada, Yokohama-shi (JP)

(21) Appl. No.: 14/124,349

(22) PCT Filed: Aug. 13, 2013
(86) PCT No.: PCT/JP2013/072038

§ 371 Date: Dec. 6, 2013

(30) Foreign Application Priority Data
Sep. 4, 2012 (JP) 2012-194407

(51) Int. Cl. G03G 15/00

(52) U.S. Cl. CPC G03G 15/70
USPC 399/21

(57) ABSTRACT

There is provided a technique for reducing the user's labor of removing, from a printing apparatus, sheets which remain on a conveyance path when a jam occurs in the printing apparatus. To achieve this, a printing apparatus according to one aspect of the invention serves as a sheet conveying apparatus for conveying a sheet through a conveyance path, which identifies a sheet jam position on the conveyance path, conveys, to a first sheet retraction unit, a sheet on the upstream side in a conveyance direction with respect to the identified jam position, and conveys, to a second sheet retraction unit, a sheet on the downstream side in the conveyance direction with respect to the identified jam position.

### TECHNICAL FIELD

The present invention relates to a sheet conveying apparatus, a method for controlling the same, and a program.

### BACKGROUND ART

In a printing apparatus, when a sheet being conveyed through a sheet conveyance path jams, it is generally necessary to stop print processing and prompt a user to remove sheets remaining on the conveyance path. In this case, to clear the jam which has occurred and restart the print processing, the user needs to remove, from the conveyance path, not only the jammed sheet but also other sheets remaining on the conveyance path due to stop of the print processing. For example, Japanese Patent Laid-Open No. 2008-176581 describes a technique of removing a jammed sheet when a jam occurs in a printing apparatus.

However, a printing apparatus used in a POD (Print On Demand) environment as described in Japanese Patent Laid-Open No. 2008-176581 has a relatively long sheet conveyance path as a sheet conveyance path. If, therefore, a jam occurs in such printing apparatus, the number of sheets to be removed from the conveyance path is large, resulting in large labor of removing the sheets.

### SUMMARY OF INVENTION

The present invention has been made in consideration of the above problem. The present invention provides a technique of reducing the user's labor of removing, from a printing apparatus, sheets which remain on a conveyance path when a jam occurs in the printing apparatus.

According to one aspect of the present invention, there is provided a sheet conveying apparatus for conveying a sheet through a conveyance path, comprising: identification means for identifying a sheet jam position on the conveyance path; and discharge control means for conveying, to a first sheet retraction unit, a sheet on an upstream side in a conveyance direction with respect to the jam position identified by the identification means, and conveying, to a second sheet retraction unit, a sheet on a downstream side in the conveyance direction with respect to the jam position identified by the identification means.

According to another aspect of the present invention, there is provided a method for controlling a sheet conveying apparatus which conveys a sheet through a conveyance path, comprising steps of: identifying a sheet jam position on the conveyance path; and conveying, to a first sheet retraction unit, a sheet on an upstream side in a conveyance direction with respect to the jam position identified in the identification step, and conveying, to a second sheet retraction unit, a sheet on a downstream side in the conveyance direction with respect to the jam position identified in the identification step.

According to the present invention, it is possible to reduce the user's labor of removing, from a printing apparatus, sheets which remain on a conveyance path when a jam occurs in the printing apparatus.

Further features of the present invention will become apparent from the following description of exemplary embodiments (with reference to the attached drawings).

### BRIEF DESCRIPTION OF DRAWINGS

FIG. 1 is a sectional view showing the overall arrangement of a printing apparatus 100 according to an embodiment of the present invention;

FIG. 2 is a block diagram showing the schematic hardware arrangement of the printing apparatus 100 according to the embodiment of the present invention;

FIG. 3 is a block diagram showing the schematic software arrangement of the printing apparatus 100 according to the embodiment of the present invention;

FIGS. 4A to 4C are schematic views each showing an example of sheet conveyance control according to the embodiment of the present invention; and

FIG. 5 is a flowchart illustrating a print processing procedure executed by the printing apparatus 100 (a printing apparatus main body 101) according to the embodiment of the present invention.

### DESCRIPTION OF EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Arrangement of Printing Apparatus 100>

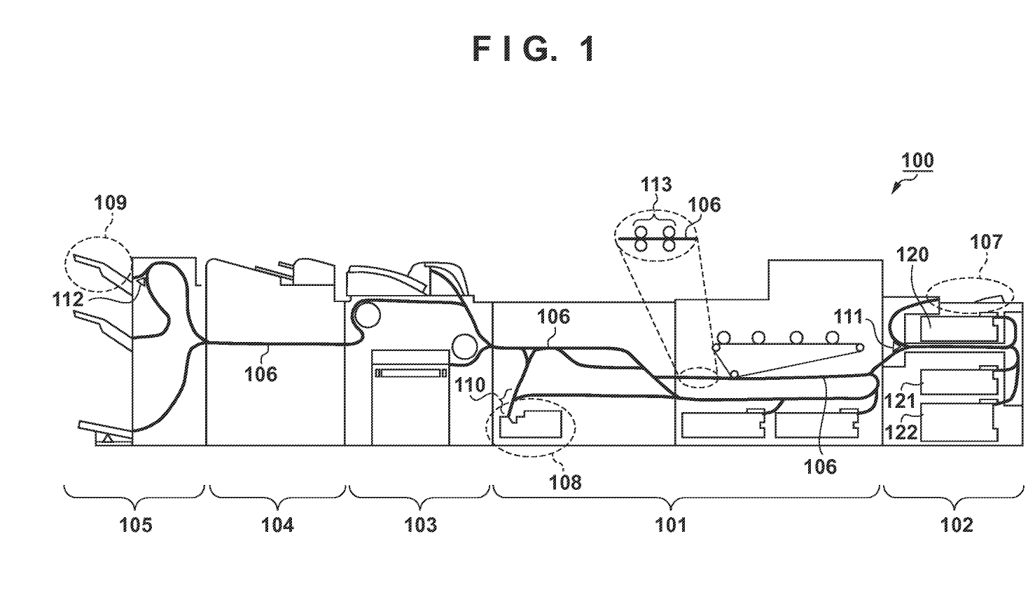

FIG. 1 is a sectional view showing the overall arrangement of a printing apparatus according to an embodiment of the present invention. In this embodiment, as an application of the present invention, the printing apparatus 100 including a printing apparatus main body 101 and accessories 102 to 105 will be explained. The accessories 102 to 105 are optional apparatuses connected to the printing apparatus main body 101. Required optional apparatuses vary depending on the arrangement of the printing apparatus main body 101. One example of the printing apparatus main body 101 does not require any optional apparatus, and another example requires at least one of optional feeding and discharge apparatuses. In this embodiment, the printing apparatus 100 having an arrangement in which the feeding accessory 102 as an optional feeding apparatus and the discharge accessories 103 to 105 as optional discharge apparatuses are connected to the printing apparatus main body 101 will be exemplified.

The feeding accessory 102 includes a plurality of feeding units 120 to 122 each of which serves as a sheet feed source and stores sheets which will undergo print processing. In response to an instruction from the printing apparatus main body 101, the feeding accessory 102 separates a plurality of sheets stored in each of the feeding units 120 to 122, and sequentially feeds the separated sheets on a conveyance path 106 one by one. Furthermore, the feeding accessory 102 can continuously feed a plurality of sheets.

Each of the discharge accessories 103 to 105 serves as a discharge destination apparatus to which a sheet having undergone print processing in the printing apparatus main body 101 is finally discharged. Each of the discharge accessories 103 to 105 is, for example, a sheet processing apparatus which performs post-processing such as bookbinding and stapling for sheets having undergone print processing or a large-volume stacker for performing stacking processing for sheets having undergone print processing.

In the printing apparatus 100, a sheet is fed from the feeding accessory 102, and then conveyed toward the printing apparatus main body 101 through the conveyance path 106. The printing apparatus main body 101 performs print processing of printing an image on the sheet conveyed through the conveyance path 106. The printing apparatus main body 101 conveys, toward the discharge accessories 103 to 105, the sheet on which the image has been printed on a surface (one side or both sides).

The printing apparatus 100 includes a plurality of sheet retraction units 107 to 109 at different positions in the middle of the conveyance path 106 of a fed sheet along the conveyance path from a sheet feed source to the discharge destination of the sheet having undergone print processing. The sheet retraction units 107 to 109 are used as the retraction destinations of sheets which remain on the conveyance path 106 when a sheet jams on the conveyance path 106 during execution of print processing. More specifically, the sheet retraction units 107 to 109 are used to discharge dischargeable ones of a plurality of sheets remaining on the conveyance path 106 (used as retraction destinations for retracting sheets from the conveyance path 106). In the printing apparatus 100, the sheet retraction units 107 to 109 are provided in the feeding accessory 102, printing apparatus main body 101, and discharge accessory 105, respectively. Note that in the embodiment, no sheet retraction unit is provided in the discharge accessory 103 or 104.

The sheet retraction unit 107 is provided in the middle of the conveyance path 106 within the feeding accessory 102. When the occurrence of double feed is detected, in which a plurality of sheets are conveyed from one of the feeding units 120 to 122 while they overlap each other without being separated, the sheet retraction unit 107 is normally used to discharge the double-fed sheets. The feeding accessory 102 can discharge a sheet on the conveyance path 106 to the sheet retraction unit 107 by operating (opening) a flapper 111 for guiding a sheet conveyed through the conveyance path 106 to the sheet retraction unit 107. In this embodiment, upon detecting the occurrence of a jam and accepting a sheet retraction instruction from the printing apparatus main body 101, the feeding accessory 102 operates the flapper 111, thereby discharging a sheet on the conveyance path 106 to the sheet retraction unit 107.

The sheet retraction unit 108 is provided in the middle of the conveyance path 106 within the printing apparatus main body 101. On the conveyance path 106, rollers 110 are used to convey a sheet to a reverse path for double-sided printing or to the sheet retraction unit 108. To perform double-sided printing for a sheet, the printing apparatus main body 101 rotates the rollers 110 in the reverse direction while the sheet is held between the rollers 110, and feeds the sheet to the reverse path. This causes the printing apparatus main body 101 to reverse the printing surface of the sheet. Furthermore, the printing apparatus main body 101 can rotate the rollers 110 to feed and discharge the sheet on the conveyance path 106 to the sheet retraction unit 108.

The sheet retraction unit 109 is provided in the middle of the conveyance path 106 within the discharge accessory 105. The sheet retraction unit 109 normally discharges a printed material having undergone test print processing for the user to confirm a printing status. That is, the sheet retraction unit 109 is used to discharge a printed material which is not used as a final product. The discharge accessory 105 can discharge a sheet on the conveyance path 106 to the sheet retraction unit 109 by operating (opening) a flapper 112 for guiding a sheet conveyed through the conveyance path 106 to the sheet retraction unit 109. In this embodiment, upon detecting the occurrence of a jam and accepting a sheet retraction instruction from the printing apparatus main body 101, the feeding accessory 105 operates the flapper 112, thereby discharging a sheet on the conveyance path 106 to the sheet retraction unit 109.

The printing apparatus 100 includes a plurality of sensors at different positions along the conveyance path 106. The plurality of sensors are provided in the printing apparatus main body 101, feeding accessory 102, and discharge accessories 103 to 105, respectively. The plurality of sensors are used to identify the positions of sheets on the conveyance path 106.

In the printing apparatus 100, a number of rollers for conveying sheets through the conveyance path 106 are provided along the conveyance path 106, in addition to the rollers 110 provided in the printing apparatus main body 101. A number of such rollers will be referred to as a roller group 113 hereinafter.

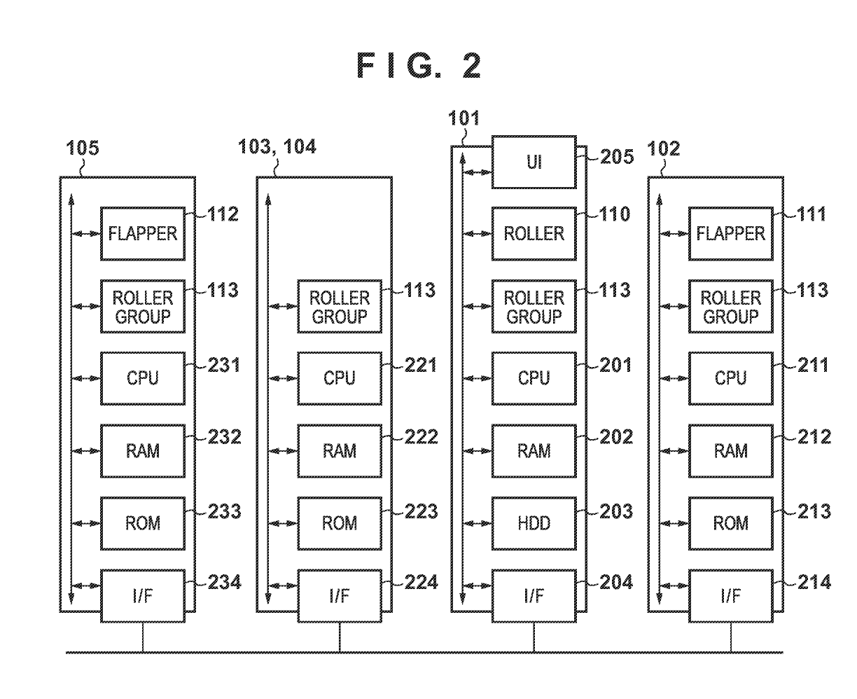

FIG. 2 is a block diagram showing the schematic hardware arrangement of the printing apparatus 100. FIG. 2 particularly shows some of the devices of the printing apparatus 100, which are involved in sheet discharge processing according to the embodiment. The discharge accessories 103 and 104 without a function of retracting a sheet have different functions while they have features in common in which there is neither a sheet retraction unit for sheet retraction on the conveyance path 106 nor a flapper (like the flappers 111 and 112) for sheet retraction. Therefore, FIG. 2 shows the common arrangement of the discharge accessories 103 and 104.

The printing apparatus main body 101 includes a CPU 201 for controlling not only the printing apparatus main body 101 but also the overall operation of the printing apparatus 100 including the feeding accessory 102 and discharge accessories 103 to 105. The printing apparatus main body 101 also includes a RAM 202, a hard disk drive (HDD) 203, an interface (I/F) 204, and a user interface (UI) 205. The RAM 202 temporarily stores software (programs) executed by the CPU 201 and data used by the CPU 201. The HDD 203 stores software and data for the operation of the printing apparatus main body 101. The I/F 204 serves as a communication interface for communication with the feeding accessory 102 and discharge accessories 103 to 105. The UI 205 functions as an input interface used by the user to input an instruction and a display interface for displaying various kinds of information such as the operation information of the printing apparatus main body 101 and notification information for the user.

The feeding accessory 102 includes a CPU 211, a RAM 212, a ROM 213, and an I/F 214, the functions of which are the same as those of the above-described CPU 201, RAM 202, HDD 203, and I/F 204, respectively. The discharge accessory 103 or 104 includes a CPU 221, a RAM 222, a ROM 223, and an I/F 224, the functions of which are the same as those of the above-described CPU 201, RAM 202, HDD 203, and I/F 204, respectively. Moreover, the discharge accessory 105 includes a CPU 231, a RAM 232, a ROM 233, and an I/F 234, the functions of which are the same as those of the above-described CPU 201, RAM 202, HDD 203, and I/F 204, respectively.

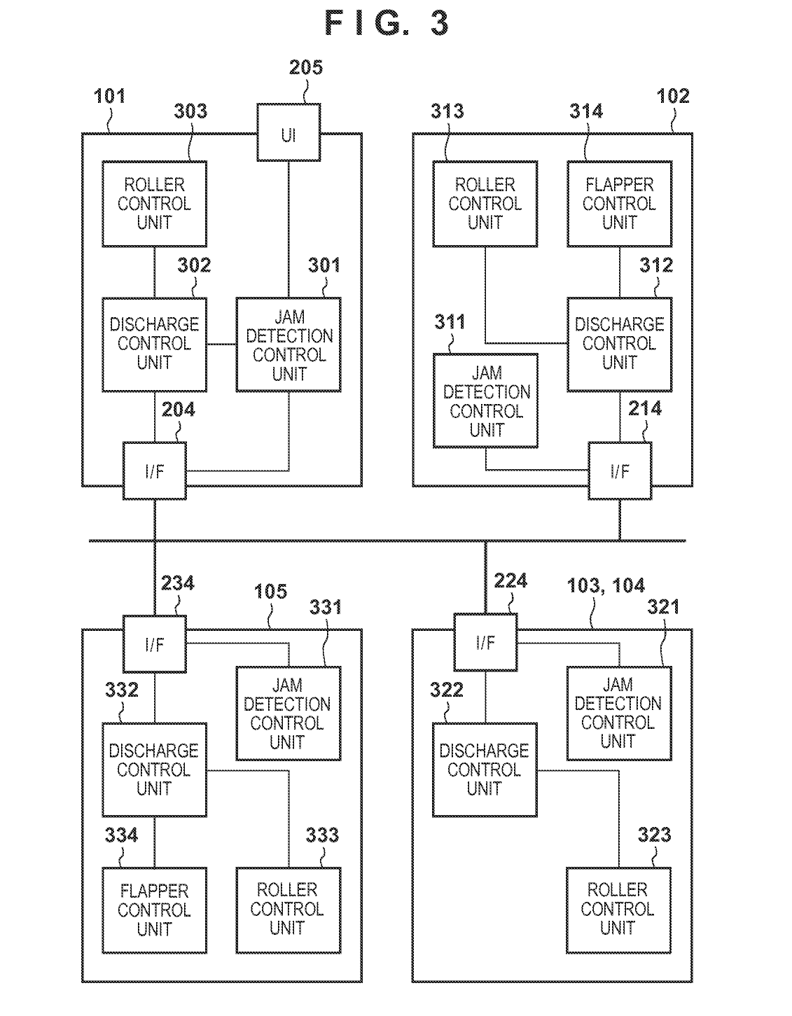

FIG. 3 is a block diagram showing the software arrangement of the printing apparatus 100. FIG. 3 particularly shows some of the software modules of the printing apparatus 100, which are involved in sheet discharge processing according to the embodiment. The function of each block shown in FIG. 3 is implemented by the CPUs 201, 211, 221, and 231 in the printing apparatus main body 101, feeding accessory 102, and discharge accessories 103 to 105, respectively. More specifically, the CPUs 201, 211, 221, and 231 read out control programs stored in the HDD 203 and ROMs 213, 223, and 233 onto the RAMs 202, 212, 222, and 223, and execute them, respectively. This processing implements the function of each block shown in FIG. 3. Note that FIG. 3 shows the common arrangement of the discharge accessories 103 and 104, similarly to FIG. 2.

In the printing apparatus main body 101, when a sheet being conveyed through the conveyance path 106 within the printing apparatus main body 101 jams during execution of print processing, a jam detection control unit 301 detects the occurrence of the jam. A discharge control unit 302 controls discharge processing for discharging, to the sheet retraction units 107 to 109, sheets remaining on the conveyance path 106 when the jam occurs. A roller control unit 303 controls the rollers 110 and the roller group 113 of the printing apparatus main body 101.

In the feeding accessory 102, when a sheet being conveyed through the conveyance path 106 within the feeding accessory 102 jams during execution of print processing, a jam detection control unit 311 detects the occurrence of the jam. The jam detection control unit 311 also transmits, to the jam detection control unit 301, a signal indicating that the occurrence of the jam has been detected. In response to an instruction from the discharge control unit 302, a discharge control unit 312 controls discharge processing for discharging, to the sheet retraction units 107 to 109, sheets remaining on the conveyance path 106 when the jam occurs. A roller control unit 313 controls the roller group 113 of the feeding accessory 102. A flapper control unit 314 controls the flapper 111.

In the discharge accessory 103 or 104, when a sheet being conveyed through the conveyance path 106 within the discharge accessory 103 or 104 jams during execution of print processing, a jam detection control unit 321 detects the occurrence of the jam. The jam detection control unit 321 also transmits, to the jam detection control unit 301, a signal indicating that the occurrence of the jam has been detected. In response to an instruction from the discharge control unit 302, a discharge control unit 322 controls discharge processing for discharging, to the sheet retraction unit 109, sheets remaining on the conveyance path 106 when the jam occurs. A roller control unit 323 controls the roller group 113 of the discharge accessory 103 or 104.

In the discharge accessory 105, when a sheet being conveyed through the conveyance path 106 within the discharge accessory 105 jams during execution of print processing, a jam detection control unit 331 detects the occurrence of the jam. The jam detection control unit 331 also transmits, to the jam detection control unit 301, a signal indicating that the occurrence of the jam has been detected. In response to an instruction from the discharge control unit 302, a discharge control unit 332 controls discharge processing for discharging, to the sheet retraction unit 109, sheets remaining on the conveyance path 106 when the jam occurs. A roller control unit 333 controls the roller group 113 of the discharge accessory 105. A flapper control unit 334 controls the flapper 112.

<Sheet Conveyance Control Upon Occurrence of Jam>

When one of sheets being conveyed through the conveyance path 106 jams, the printing apparatus 100 normally stops print processing being executed. As a result, a number of sheets remain on the conveyance path 106. In this case, to clear the jam which has occurred, and cause the printing apparatus 100 to restart the print processing, the user needs to remove not only the jammed sheet but also other sheets remaining on the conveyance path 106, resulting in a time-consuming operation. Especially, as the conveyance path 106 is longer, the number of sheets to be removed when a jam occurs becomes larger, thereby imposing larger labor of removing the sheets. In this case, therefore, it is desirably possible to reduce the user's labor as much as possible.

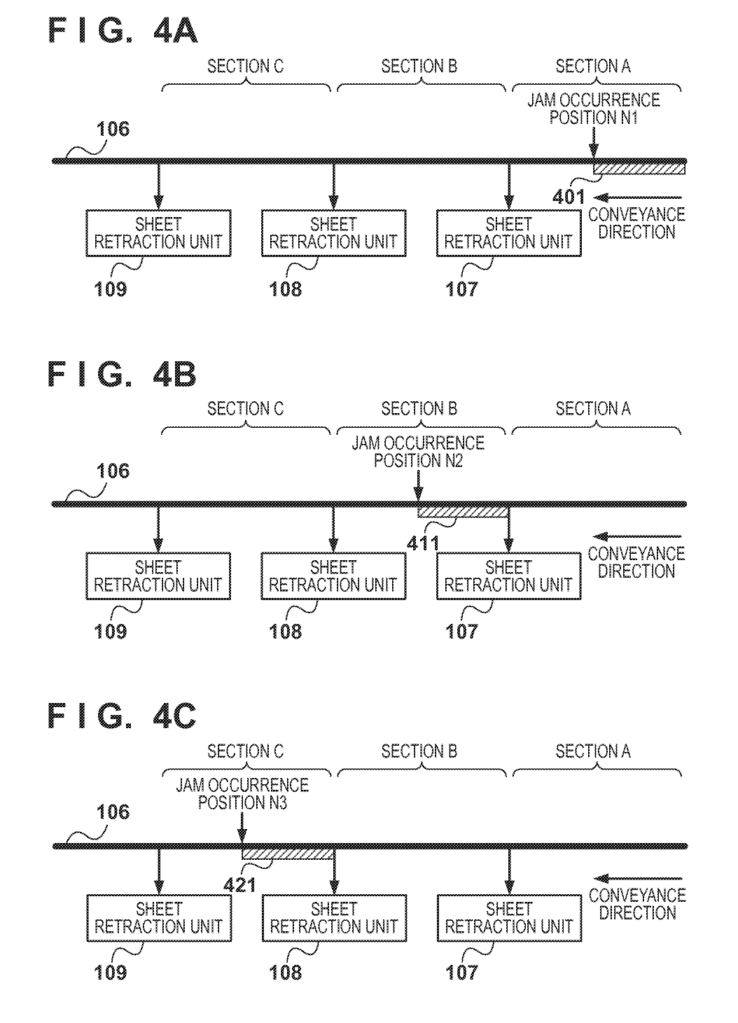

To solve the above-described problem, this embodiment features that when a sheet jam occurs on the conveyance path 106, sheets remaining on the conveyance path 106 are automatically discharged to the sheet retraction units 107 to 109 as many as possible. By enabling sheets remaining on the conveyance path 106 to be removed from the sheet retraction units 107 to 109 as many as possible at once, the user's labor is reduced. An example of sheet conveyance control according to this embodiment, which is executed in the printing apparatus 100 when a sheet jam occurs on the conveyance path 106, will be described below with reference to FIGS. 4A to 4C.

Each of FIGS. 4A to 4C shows the sheet conveyance path 106 from a sheet feed source (one of the feeding units 120 to 122) to a discharge destination (in this example, the discharge accessory 105), and the sheet retraction units 107 to 109 provided in the middle of the conveyance path 106 along the conveyance path 106. A section from the sheet feed source to the sheet retraction unit 107 is defined as section A, a section from the sheet retraction unit 107 to the sheet retraction unit 108 is defined as section B, and a section from the sheet retraction unit 108 to the sheet retraction unit 109 is defined as section C. FIG. 4A, 4B, or 4C corresponds to a case in which a sheet being conveyed jams in section A, B, or C, and also shows a jam occurrence position N1, N2, or N3.

(When Jam Occurs in Section A)

FIG. 4A shows a case in which a sheet jam occurs at the position N1 in section A of the conveyance path 106. In this case, the printing apparatus 100 cannot convey a sheet remaining in a section 401 on the upstream side in a conveyance direction with respect to the position N1 on the conveyance path 106 toward the downstream side in the conveyance direction with respect to the position N1. On the other hand, each sheet remaining on the downstream side in the conveyance direction with respect to the position N1 on the conveyance path 106 can be discharged by using one of the sheet retraction units 107 to 109 as a retraction destination without being disturbed by the jammed sheet. For example, each of sheets remaining in section A except for the section 401, section B, and section C is automatically discharged to the nearest one of the sheet retraction units 107, 108, and 109 on the downstream side in the conveyance direction.

(When Jam Occurs in Section B)

FIG. 4B shows a case in which a sheet jam occurs at the position N2 in section B of the conveyance path 106. In this case, the printing apparatus 100 cannot convey a sheet remaining in a section 411 on the upstream side in the conveyance direction with respect to the position N2 on the conveyance path 106 toward the downstream side in the conveyance direction with respect to the position N2. On the other hand, each sheet remaining on the downstream side in the conveyance direction with respect to the position N2 on the conveyance path 106 can be discharged by using the sheet retraction unit 108 or 109 as a retraction destination without being disturbed by the jammed sheet. For example, each of sheets remaining in section B except for the section 411 and section C is automatically discharged to the nearest one of the sheet retraction units 108 and 109 on the downstream side in the conveyance direction. Furthermore, each sheet remaining in section A can also be discharged by using, as a retraction destination, the nearest sheet retraction unit 107 on the downstream side in the conveyance direction without being disturbed by the jammed sheet.

(When Jam Occurs in Section C)

FIG. 4C shows a case in which a sheet jam occurs at the position N3 in section C of the conveyance path 106. In this case, the printing apparatus 100 cannot convey a sheet remaining in a section 421 on the upstream side in the conveyance direction with respect to the position N3 on the conveyance path 106 toward the downstream side in the conveyance direction with respect to the position N3. On the other hand, each sheet remaining on the downstream side in the conveyance direction with respect to the position N3 on the conveyance path 106 can be discharged by using the sheet retraction unit 109 as a retraction destination without being disturbed by the jammed sheet. Furthermore, each of sheets remaining in section A and section B can also be discharged by using, as a retraction destination, the nearest one of the sheet retraction units 107 and 108 on the downstream side in the conveyance direction without being disturbed by the jammed sheet.

Note that in any case shown in FIG. 4A, 4B, or 4C, sheets remaining on the downstream side in the conveyance direction with respect to the position of the sheet retraction unit 109 on the conveyance path 106 may be discharged to a final discharge destination (the discharge accessory 105).

As described above, in the example shown in FIG. 4A, 4B, or 4C, the printing apparatus 100 identifies sheets which can be conveyed up to one of the sheet retraction units 107 to 109 without passing through the jam occurrence positions N1, N2, or N3 when conveying each sheet remaining on the conveyance path 106 from its position in the conveyance direction. Furthermore, the printing apparatus 100 determines the identified sheets as sheets each dischargeable to one of the sheet retraction units 107 to 109. For example, in FIG. 4A, 4B, or 4C, sheets remaining in a section except for the section 401, 411, or 421 are identified as sheets each dischargeable to one of the sheet retraction units 107 to 109. Moreover, the printing apparatus 100 decides one of the sheet retraction units 107 to 109 as the retraction destination of each identified sheet, and then automatically discharges the sheet to the decided sheet retraction unit.

<Print Processing of Printing Apparatus 100>

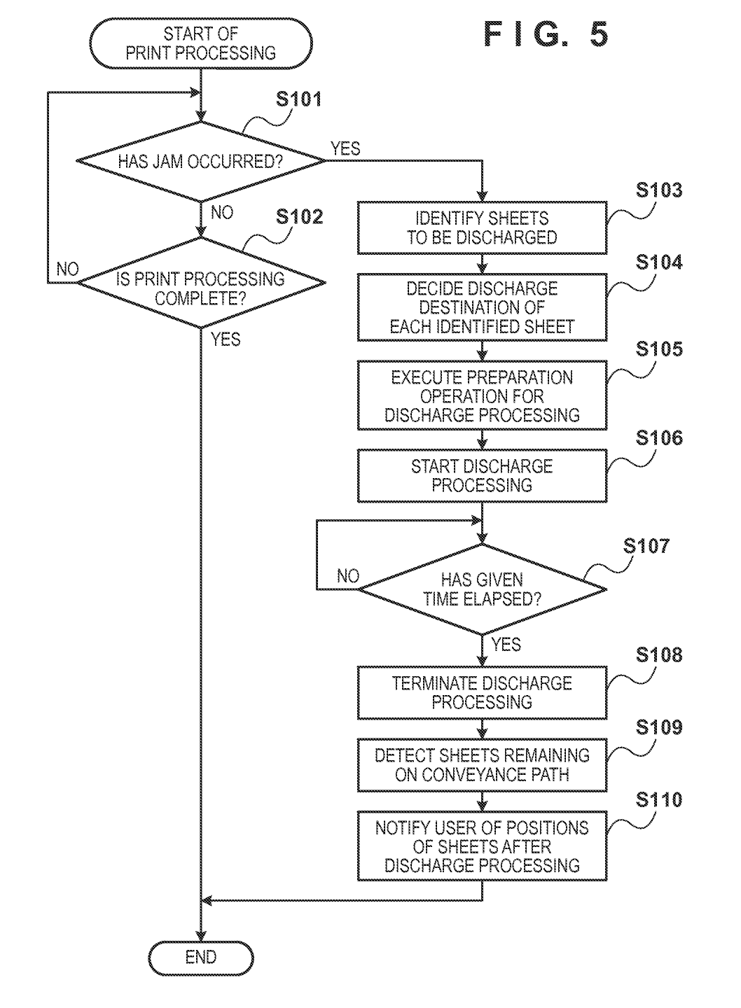

FIG. 5 is a flowchart illustrating a sheet conveyance control procedure when a jam occurs, which is executed in the printing apparatus 100 according to the embodiment. In this embodiment, processing in each step of FIG. 5 is implemented in the printing apparatus 100 (printing apparatus main body 101) when the CPU 201 of the printing apparatus main body 101 reads out a control program stored in the HDD 203 onto the RAM 202, and executes it.

Upon start of print processing for sheets in the printing apparatus 100, the CPU 201 feeds sheets from one of the feeding units 120 to 122 of the feeding accessory 102 to the conveyance path 106, and starts to convey the sheets through the conveyance path 106 in a predetermined conveyance direction. For example, the CPU 201 starts print processing based on an instruction (print job) input by the user via the UI 205 or an instruction (print job) received from an external apparatus via a network (not shown).

In step S101, the jam detection control unit 301 (CPU 201) determines whether a sheet jam has occurred on the conveyance path 106 within one of the printing apparatus main body 101, feeding accessory 102, and discharge accessories 103 to 105 during execution of print processing. Upon detecting that one of the plurality of sheets being conveyed through the conveyance path 106 has jammed, the sensor within the printing apparatus main body 101, of the plurality of sensors provided along the conveyance path 106, outputs to the jam detection control unit 301 a signal indicating that the jam has occurred. Similarly, upon detecting the occurrence of the jam, the sensors provided in the feeding accessory 102 and discharge accessories 103 to 105 output, to the jam detection control units 311, 321, and 331, a signal indicating that the jam has occurred, respectively. Each of the jam detection control units 311, 321, and 331 transmits the signal to the jam detection control unit 301.

In step S101, based on the signals received from the above-described plurality of sensors, the jam detection control unit 301 detects that one of the sheets being conveyed through the conveyance path 106 has jammed. If the jam detection control unit 301 determines the occurrence of a jam in step S101, it advances the process to step S103; otherwise, it advances the process to step S102.

In step S102, the CPU 201 determines whether the print processing based on the print job is complete. If the CPU 201 determines that the print processing defined by the print job is complete, it ends the process; otherwise, it returns the process to step S101 to continue the print processing.

If the process advances from step S101 to step S103, in step S103 the CPU 201 stops the print processing, and identifies sheets each dischargeable to one of the sheet retraction units 107 to 109 among sheets remaining on the conveyance path 106. Furthermore, for each identified sheet, the CPU 201 decides one of the sheet retraction units 107 to 109 to be used as a sheet retraction destination, and discharges the identified sheet to the decided sheet retraction unit. In this way, the CPU 201 executes discharge control for automatically discharging (retracting), to one of the sheet retraction units 107 to 109, each sheet which remains on the conveyance path 106 when a jam occurs, instead of making the user remove the sheets. That is, the CPU 201 executes discharge control for discharging each identified sheet to the decided sheet retraction unit while the jammed sheet remains on the conveyance path 106.

In step S103, the CPU 201 identifies sheets each dischargeable to one of the sheet retraction units 107 to 109 among the sheets remaining on the conveyance path 106. In this embodiment, as an example, the above-described plurality of sensors provided along the conveyance path 106 are used to identify such sheets.

The CPU 201 identifies the positions of the plurality of sheets remaining on the conveyance path 106 based on the signals output from the plurality of the sensors. Note that the CPU 201 may receive, via the CPUs 211, 221, and 231, the signals output from the sensors provided in the feeding accessory 102 and discharge accessories 103 to 105, respectively.

Note that as described above, when a jam occurs in a section between the position of an identified sheet and the position of one of the sheet retraction units existing on the downstream side in the conveyance direction on the conveyance path 106, it is impossible to convey or discharge the sheet to any one of the sheet retraction units 107 to 109. To address this, the CPU 201 identifies, as a dischargeable sheet, a sheet which can be conveyed up to one of the sheet retraction units 107 to 109 without passing through the jam occurrence position when conveying the sheet from a position identified using the plurality of sensors in the conveyance direction on the conveyance path 106.

In step S104, for each sheet identified in step S103, the CPU 201 decides one of the sheet retraction units 107 to 109 to be used as a sheet retraction destination. In this embodiment, as an example, for each identified sheet, the CPU 201 decides, as a sheet retraction unit to be used as a retraction destination, one of the sheet retraction units 107 to 109, which is nearest on the downstream side in the conveyance direction from the position identified using the plurality of sensors as described above. In this case, each of the flappers 111 and 112 may be opened. Furthermore, sheet discharge control may be performed by operating (rotating) rollers (some of the roller groups 113, rollers 110, and the like) necessary for conveying each sheet identified in step S103 to the sheet retraction unit decided in step S104 on the conveyance path 106.

In step S105, the discharge control unit 302 (CPU 201) executes a preparation operation for the discharge processing for retracting each sheet identified in step S103 to the sheet retraction unit decided in step S104. More specifically, the discharge control unit 302 transmits a discharge preparation command to the discharge control units 312, 322, and 332 (of the feeding accessory 102 and discharge accessories 103 to 105) via the I/F 204. The discharge control unit 302 also executes a preparation operation for sheet discharge processing in the printing apparatus main body 101. In response to the discharge preparation command, the discharge control units 312 and 332 cause the flapper control units 314 and 334 to open the flappers 111 and 112, respectively, as the preparation operation for the sheet discharge processing.

In step S106, the discharge control unit 302 starts the discharge processing for retracting each sheet identified in step S103 to the sheet retraction unit decided in step S104. More specifically, the discharge control unit 302 transmits a discharge start command to the discharge control units 312, 322, and 332 (of the feeding accessory 102 and discharge accessories 103 to 105) via the I/F 204. The discharge control units 312, 322, and 332 cause the roller control units 313, 323, and 333 to start the operations of some of the rollers included in the roller groups 113, which are necessary for conveying each sheet identified in step S103 to the sheet retraction unit decided in step S104. Similarly, the discharge control unit 302 also starts the operations of necessary ones of the rollers included in the roller group 113. Furthermore, the discharge control unit 302 starts the operations of the rollers 110 when discharging the sheet to the sheet retraction unit 107 of the printing apparatus main body 101. Note that the rollers included in the roller groups 113 may be controlled to rotate in the sheet feeding direction (conveyance direction) in normal execution of print processing. The rollers 110 may be controlled to rotate in the direction in which the sheet is conveyed to the sheet retraction unit 107.

In step S107, the discharge control unit 302 determines whether a given time has elapsed after the start of the sheet discharge processing in step S106. The given time is set as a time required by each sheet, which has been identified in step S103 and remains on the conveyance path 106, to reach one of the sheet retraction units 107 to 109 which has been decided as a retraction destination. If the discharge control unit 302 determines in step S107 that the given time has elapsed, it advances the process to step S108.

In step S108, the discharge control unit 302 terminates the sheet discharge processing. More specifically, the discharge control unit 302 transmits a discharge end command to the discharge control units 312, 322, and 332 via the I/F 204, and also terminates the discharge processing in the printing apparatus main body 101. In response to reception of the discharge end command, the discharge control units 312, 322, 332 cause the roller control units 313, 323, and 333 to stop the operations of the rollers included in the roller groups 113, respectively. Furthermore, the discharge control unit 302 causes the roller control unit 303 to stop the operations of the rollers included in the roller group 113 and the rollers 110.

After that, in step S109, the jam detection control unit 301 executes processing of detecting sheets remaining on the conveyance path 106 to identify the positions of the sheets remaining on the conveyance path 106 after the sheet discharge processing in steps S105 to S108. The sheets remaining on the conveyance path 106 include the jammed sheet and sheets which have not been identified in step S103 and remain on the conveyance path 106 without being discharged to any of the sheet retraction units 107 to 109.

In step S109, the jam detection control unit 301 transmits a sheet detection command to the jam detection control units 311, 321, and 331 (of the feeding accessory 102 and discharge accessories 103 to 105) via the I/F 204, and receives, as a response to it, information indicating a sheet detection result. The detection result includes information indicating the position of each sheet remaining on the conveyance path 106. Note that the jam detection control units 311, 321, and 331 detect the sheets using the above-described sensors, thereby identifying the positions of the sheets. Furthermore, the jam detection control unit 301 detects each sheet remaining on the conveyance path 106 within the printing apparatus main body 101 using the above-described sensors, thereby identifying the position of each sheet.

Finally, in step S110, the CPU 201 notifies the user of the positions of the sheets after the discharge processing based on the information decided in step S104 and the information obtained by the jam detection control unit 301. This notification may be done by, for example, displaying, on the UI 205, information indicating the positions of the sheets after the discharge processing. This prompts the user to remove the sheets from the printing apparatus 100.

More specifically, the CPU 201 notifies the user of the sheet retraction units (that is, one or more of the sheet retraction units 107 to 109) to which the sheets identified in step S103 have been discharged in the discharge processing in steps S105 to S108. Note that the notification about the sheet retraction units 107 to 109 may be done by display control of LEDs and the like provided in the sheet retraction units 107 to 109, instead of display on the UI 205. With this processing, the user is notified of one or more of the sheet retraction units 107 to 109 from which the sheets need to be removed, after automatically discharging the sheets from the conveyance path 106.

Furthermore, the CPU 201 displays, on the UI 205, the positions of the sheets including the jammed sheet, which remain on the conveyance path 106 without being discharged to the sheet retraction units 107 to 109. With this operation, the user is notified of the positions on the conveyance path 106 from which the sheets need to be removed.

As described above, in this embodiment, the printing apparatus 100 identifies sheets each dischargeable to one of the sheet retraction units 107 to 109 among a plurality of sheets remaining on the conveyance path 106 when one of sheets being conveyed jams. Furthermore, the printing apparatus 100 decides, for each identified sheet, one of the sheet retraction units 107 to 109 to be used as a sheet retraction destination, and discharges the identified sheet to the decided sheet retraction unit.

According to this embodiment, the user can remove, at once, from the sheet retraction units 107 to 109, most of sheets remaining on the conveyance path 106 when a jam occurs. That is, the user can remove, at once, from the sheet retraction units 107 to 109, sheets except for a sheet which has physically jammed on the conveyance path 106 and except for sheets which could not be automatically discharged. This can reduce the user's labor of removing sheets when a jam occurs.

Note that various modifications can be made to the above-described embodiment to implement the present invention. For example, the decision processing in step S104 of FIG. 5 may be changed as follows. That is, on each of the upstream side and downstream side with respect to a jam occurrence position on the conveyance path 106, a sheet retraction unit positioned most downstream in the conveyance direction may be decided as the retraction destination of each sheet remaining on each of the upstream side and downstream side. Note that in this embodiment, the sheet retraction unit 107 and 109 are decided. This makes it possible to discharge, at once, sheets identified as automatic discharge targets to the sheet retraction units, the number of which is smaller than that in the above-described embodiment. With this operation, it is possible to further reduce the user's labor of removing sheets when a jam occurs.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-194407, filed Sep. 4, 2012, which is hereby incorporated by reference herein in its entirety.

1. A printing apparatus for printing an image on a sheet, and conveying the sheet to a sheet processing apparatus, comprising:
a determining unit configured to determine whether a sheet jam occurs on a conveyance path for conveying a sheet; and
a discharge control unit configured to control, in a case where the determining unit determines that the sheet jam occurs on the conveyance path, to convey a first sheet on the conveyance path to a first sheet holding unit of the printing apparatus, and to convey a second sheet on the conveyance path to a second sheet holding unit of the sheet processing apparatus, before a sheet which has jammed is removed from the conveyance path.

2. The printing apparatus according to claim 1, wherein in a state that the jammed sheet is not removed from the conveyance path, the discharge control unit controls to convey the first sheet, to the first sheet holding unit and to convey the second sheet to the second sheet holding unit.

3. The printing apparatus according to claim 2, further comprising
a notification unit configured to notify a user to remove the jammed sheet after the first sheet is conveyed, to the first sheet holding unit, and the second sheet is conveyed to the second sheet holding unit.

4. The printing apparatus according to claim 3, wherein the notification unit further notifies the user of a position of the jammed sheet on the conveyance path.

5. The printing apparatus according to claim 1, further comprising
a sensor used for sensing a sheet on the conveyance path,
wherein the determining unit determines whether the sheet jam occurs on the conveyance path based on a signal from the sensor.

6. The printing apparatus according to claim 1, wherein
the first sheet holding unit has a shortest conveyance distance from the first sheet, and
the second sheet holding unit has a shortest conveyance distance from the second sheet.

7. The printing apparatus according to claim 2, further comprising
a notification unit configured to notify a user that the first sheet has been conveyed to the first sheet holding unit and the second sheet has been conveyed to the second sheet holding unit.

8. (canceled)

9. A method for controlling a printing apparatus for printing an image on a sheet, and conveying the sheet to a sheet processing apparatus, comprising:
determining whether a sheet jam occurs on a conveyance path for conveying a sheet; and
controlling, in a case where it is determined that the sheet jam occurs on the conveyance path, to convey a first sheet on the conveyance path to a first sheet holding unit of the printing apparatus and to convey a second sheet on the conveyance bath to a second sheet holding unit of the sheet processing apparatus, before a sheet which has jammed is removed from the conveyance path.

10. A non-transitory computer-readable storage medium storing a computer program for causing a computer to execute steps of a method for controlling a printing apparatus, the method comprising:
determining whether a sheet jam occurs on a conveyance path for conveying a sheet; and
controlling, in a case where it is determined that the sheet jam occurs on the conveyance path, to convey a first sheet on the conveyance path to a first sheet holding unit of the printing apparatus, and to convey a second sheet on the conveyance path to a second sheet holding unit of the sheet processing apparatus, before a sheet which has jammed is removed from the conveyance path.
